(19) United States
(12) Patent Application Publication
(10) Pub. No.: US 2006/0126840 A1
(43) Pub. Date: Jun. 15, 2006

(54) Conditionally blocking reproduction of content items

(76) Inventors: Gerhardus Engbertus Mekenkamp, Eindhoven (NL); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/520,312

(22) PCT Filed: Jun. 19, 2003
(86) PCT No.: PCT/IB03/02872

§ 371 Date: Jan. 5, 2005

(30) Foreign Application Priority Data
Jul. 11, 2002 (EP) 02077836.1

(51) Int. Cl. H04K 1/00

(52) U.S. Cl. 380/255

(57) ABSTRACT

A reproduction device (200) is arranged to conditionally block the reproduction of a particular content item (324). The reproduction has a unit (202) to obtain a content reference identifier (330) identifying the particular content item (324) and a storage unit (204) for storing the content reference identifier (330). A resolution process regularly checks on the basis of the content reference identifier (330) whether the particular content item is scheduled to be available, e.g. is scheduled for broadcast. When the scheduled broadcast of the particular item has been established, a blocking unit (210) blocks the reproduction device for that scheduled broadcast.

The invention relates to a method of conditionally blocking reproduction of content items on a reproduction device.

The invention further relates to a method of providing blocking information for conditionally blocking reproduction of content items on a reproduction device.

The invention further relates to a reproduction device for conditionally blocking reproduction of content items.

The invention further relates to a set-top box, to a television set and to a video recorder comprising such a reproduction device.

The invention further relates to a system for providing blocking information for conditionally blocking reproduction of content items on a reproduction device.

European Patent 963114 B1 describes a system wherein content items, there called programs or portions of programs, can be blocked on the basis of a viewing profile. In this system, a source signal carries the content items to be viewed at the subscriber's location. In addition to the content item, the source signal contains an embedded content identifier describing a certain aspect of that content item. Examples of such aspects are the type of the content item and the suitability of the content item being viewed by children. At the subscriber's location, the content identifier is compared with the viewing profile and on the basis of this comparison the reproduction of the content item is blocked or not. The viewing profile can be used for parental control because a parent can prohibit children from viewing programs that are regarded unsuitable. The system relies on the co-operation of the broadcaster to embed the content identifier in the program. Furthermore, the value of the content identifier for a specific content item is determined by or on behalf of the broadcaster. This is subject to the broadcaster's interpretation of the content item and to the broadcaster's appreciation of what is suitable for children and what not.

It is an object of the invention to provide a method of conditionally blocking reproduction of content items on a reproduction device providing a more flexible control of blocking a content item. This object is achieved according to the invention in a method comprising:

obtaining a content reference identifier for a particular content item to be blocked,
resolving the content reference identifier into a locator indicating availability of the particular content item, and
blocking the reproduction device for the indicated availability.

By using a content reference identifier for a content item to be blocked, blocking of reproduction of the content item can be effected without having to rely on the co-operation of the broadcaster for transmitting an indication along with the content item. The content reference identifier, identifying the content item, can be obtained using another mechanism than the one for obtaining the content item itself. This means that the information that a content item is to be blocked is provided in a different way than the content item. This allows for example that, prior to providing the content item, it is indicated that the reproduction of a content item is to be blocked. Indicating that the reproduction is to be blocked may be given even so far ahead that it is not yet known when the content item is scheduled to be provided. In that case, the content reference identifier for the particular content item is simply stored and at regular times it is checked whether the schedule has become known. As soon as it has become known, the reproduction device is programmed to be blocked accordingly.

It is to be noted that the content identifier used in the system known from European Patent 963114 B1 is fundamentally different from the content reference identifier according to the invention. The known content identifier in European Patent 963114 B1 describes a certain property of the content item, for example the suitability of the content item being watched by children. An example of the know content identifier is “PG 13”, indicating that a parent should be present if the content item is watched by children younger than 13. The content reference identifier according to the invention only identifies the content item and does not describe a certain property of the content item. The content reference identifier according to the invention provides an identification, which makes it possible, that different parties refer to this one content item. An example of the content reference identifier is “Alien”, referring to a content item that is the movie called Alien.

An embodiment of the method according to the invention is described in claim 2. The invention can advantageously be applied in a broadcast environment, where a broadcaster transmits radio and TV programs according to a given schedule. At some moment, the user of the reproduction device, e.g. the television or the set-top box, may determine the existence of a particular content item that he regards unsuitable to be reproduced on his reproduction device. The user then obtains the content reference identifier for that content item and stores it in the reproduction device thereby indicating that reproduction of that item is to be blocked. Some time after storing the content reference identifier in the reproduction device, this content reference identifier is resolved, i.e. translated, into information related to the broadcast schedule. Then it becomes known when and at which channel the content item will be broadcast and the reproduction device is programmed to be blocked accordingly.

An embodiment of the method according to the invention is described in claim 3. In such an environment, where content items are retrieved on the initiative of the user rather then broadcast on the initiative of the broadcaster as in the broadcast environment, the invention can also be applied advantageously. An example of such an environment is a video-on-demand server where a video program is transmitted to a user's reproduction device on the request of the user. Another example is an Internet server comprising various content items, e.g. video clips that may be selected for downloading to, or reproduction on, the reproduction device. In this embodiment, the content reference identifier is resolved into the name of the providing server and the period during which the server keeps the particular content item available for retrieval. After resolution of the content reference identifier, the reproduction device is programmed to be blocked for retrieval of the particular content item from the named server for the indicated period.

An embodiment of the method according to the invention is described in claim 4. In this embodiment, an authorized user may overrule the blocking of the reproduction device. This may be used for parental guidance, where the reproduction device is blocked to prevent a child watching a particular content item on its own, but where the parent can overrule the blocking to be able to watch the content item.

An embodiment of the method according to the invention is described in claim 6. A further advantage of providing the information that reproduction of a content item is to be blocked separate from providing the content item is, that the information may be obtained from a different party than the party providing the content item. The user of the reproduction device may want to use the advice concerning blocking certain contain items from that party, e.g. because the user trusts the opinion of that party regarding the suitability of content items for children. Such party may be a school organization, a consumer organization, a religious organization, or other organization that promotes certain ethic values. The organization may host a website offering various blocking lists. Textual descriptions can inform the user about the purpose of each of the lists. The user can select a list to transmit the content reference identifiers to the reproduction device.

An embodiment of the method according to the invention is described in claim 7. This embodiment provides an easy and simple mechanism for the user to obtain the content reference identifier for the particular item. Here, the content reference identifier of the particular item is sent to the reproduction device during reproduction of another content item. An example is that during reproduction of a commercial announcing or describing the particular content item, the content reference identifier of the particular content item is available in the signal. The user is given the option to indicate that reproduction of the particular content item should be blocked and if the user does so, the content reference identifier is stored in the reproduction device. Another example is that in the trailer of a movie, a later movie is announced and the content reference identifier for the later movie is embedded in the signal. The user seeing the announcement of the later movie decides that this movie is not suitable for reproduction on the user's reproduction device and indicates such, for example by pressing a reject button on the remote control. In practice, the term trailer is not only used for announcements literally trailing a program but the term is also used for a general program announcement.

It is a further object of the invention to provide a method of providing blocking information for conditionally blocking reproduction of content items on a reproduction device allowing a more flexible control of blocking a content item. This object is achieved according to the invention in a method comprising:
preparing an advisory list containing a reference to a particular content item and containing a content reference identifier for that particular content item, and
making the advisory list available for transfer to and use in the reproduction device for
   resolving the content reference identifier into a locator indicating availability of the particular content item, and
   blocking the reproduction device for the indicated availability.

This method according to the invention makes it possible to provide blocking information for a particular content item separate from providing the content item itself. Thus the blocking information about a content item can then easily be assembled and provided by a different party than the party providing the content item.

It is a further object of the invention to provide a reproduction device for conditionally blocking reproduction of content items with a more flexible control of blocking a content item. This object is achieved in a reproduction device comprising:
obtaining means for obtaining a content reference identifier for a particular content item to be blocked,
receiving means for receiving the result of resolving the content reference identifier into a locator indicating availability of the particular content item, and
blocking means for blocking the reproduction device for the indicated availability.

In the reproduction device according to the invention, the information that reproduction of the particular content is to be blocked may be received separately from the content item itself. The blocking information can be obtained as soon as the user is aware of the particular content item and prior to the content item itself becoming available. The blocking information is received in the form of the content reference identifier and may be stored in the device for later resolution. The resolution may be done external to the reproduction device and when the device receives the resolution result, indicating the availability of the particular content item, the device is programmed to be blocked accordingly.

An embodiment of the reproduction device according to the invention is described in claim 12. Since this reproduction device is able to resolve the content reference identifier internally, it does not need an external service for obtaining the locator information. To this end, the reproduction device receives resolution information enabling the resolution of the content reference identifier into the locator. An example of this is that the reproduction device receives the content items in a channel of a DVB transport stream and that the resolution information is sent in a data stream of the DVB transport stream.

The system according to the invention for providing blocking information for conditionally blocking reproduction of content items on a reproduction device comprises:
preparation means for preparing an advisory list containing a reference to a particular content item and containing a content reference identifier for that particular content item, and
managing means for making the advisory list available for transfer to and use in the reproduction device for
   resolving the content reference identifier into a locator indicating availability of the particular content item, and
   blocking the reproduction device for the indicated availability.

The invention and its attendant advantages will be further elucidated with the aid of exemplary embodiments and the accompanying schematic drawings, wherein:

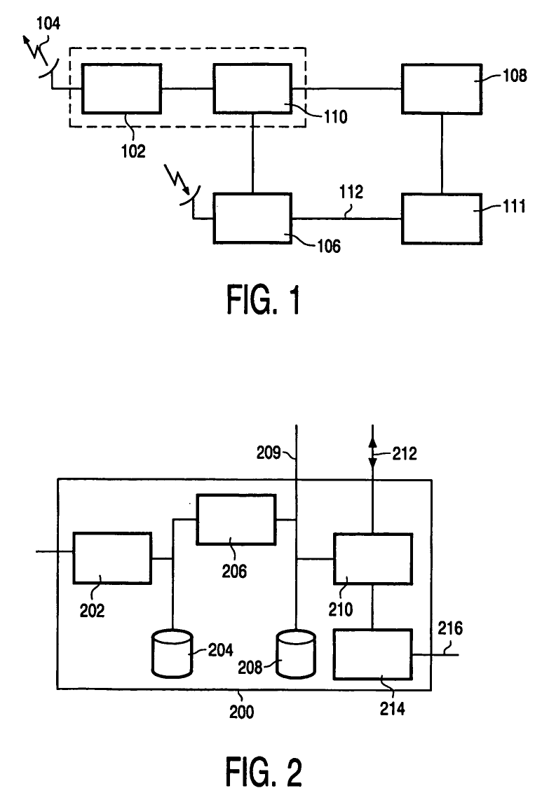

FIG. 1 shows an overview of the operation of the invention,

FIG. 2 schematically shows the most important components of a reproduction device according to the invention,

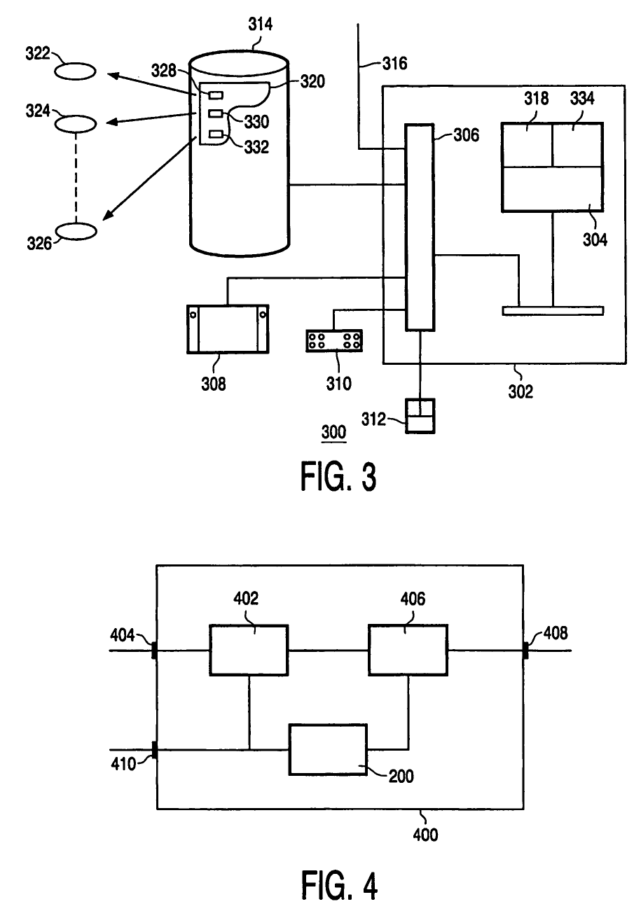

FIG. 3 schematically shows a system for providing blocking information according to the invention,

FIG. 4 schematically shows a set-top box according to the invention,

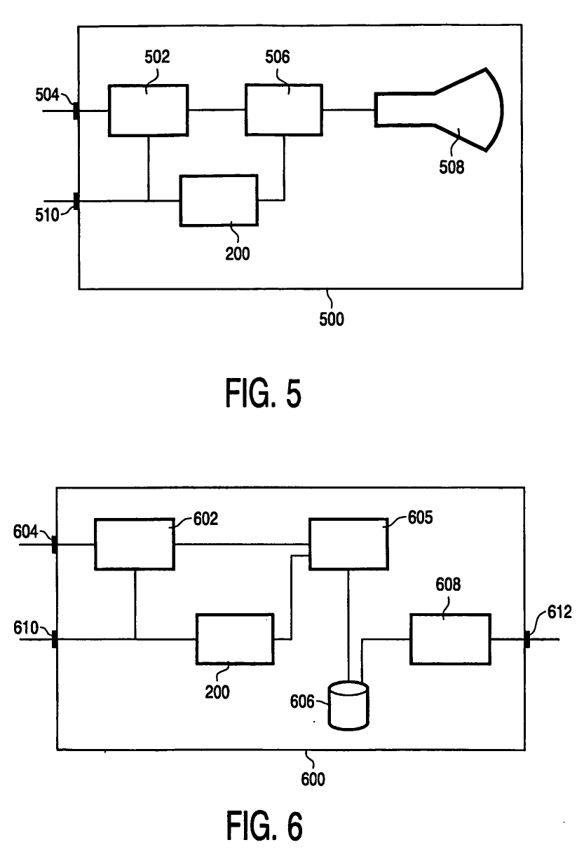

FIG. 5 schematically shows a television according to the invention, and

FIG. 6 schematically shows a video recorder according to the invention.

Corresponding features in the various Figures are denoted by the same reference symbols.

FIG. 1 shows an overview of the operation of the invention. The invention uses the concept of a content reference identifier. This content reference identifier or CRID uniquely identifies each individual content item. The CRID does not identify a particular broadcast of a content item like a program, but identifies the program as such. Therefore a repeat of a program will usually have the same CRID as the original broadcasting. The CRID for a program resembles the ISBN (International Standard Book Number) for a book, since the ISBN also uniquely identifies the book. The CRID is not limited to broadcast transmissions of content items. It could also be used to identify content items available on the Internet or any other source. When the CRID of a specific content item has been obtained by the user, the next step is to resolve the CRID into a locator indicating when and where the content item will be available. In the broadcast environment, the locator is the scheduled broadcast of the program indicating the time and channel of broadcast. One can search for content items like movies and obtain CRIDs for the content items while the broadcast details of the movies are not yet known.

The concept of content reference identifier is also of interest for recording of programs. For example a user may want to record an episode of a television series, but he does not necessarily know when and where that episode will become available. He can then use his personal digital recorder (PDR) or similar device to enter a reference to the episode or series by means of the CRID. Note that a CRID may refer to an entire series or to an individual episode thereof or even to a segment of an episode. Having received a CRID for a content item, the PDR tries to obtain the location of the content item. This information is called a locator and it contains the date, time and channel on which the content item will be broadcast. The user however does not need to be aware of this. Once the PDR has obtained the locator of the content item, the PDR waits for the specified date and time and then records the episode as it is broadcast on the specified channel. Of course, if the locator indicates a location on the Internet or the like, the PDR can simply retrieve the content from the indicated location as soon as it becomes available.

In the context of recording of programs, the TV-Anytime standardization body provides a standardized Content Reference ID. See TV-Anytime Forum, www.tv-anytime.org, Specification Series: S-4, on Content Referencing (Normative), Document SP004V11, 14 Apr. 2001.

The syntax of the CRID as used by TV-Anytime is as follows: CRID://<authority>/<data>

The <authority> field indicates the body that created the CRID. An authority will also provide the ability for the CRID to be resolved into locators or other CRIDs. A locator is the name for locations in time and space of content. The <data> field is a free format string that is compliant with the definition of Uniform Resource Identifiers (URIs) as given in RFC 2396. This string should be meaningful to the authority given by the <authority> field.

The CRID is used for location resolution, which can be defined as the process of translating a CRID into other CRID(s) or locators. For instance, a CRID for an entire TV series could be translated into a series of CRIDs for the individual episodes of that series. Location resolution may be done in the recording device (typically a Personal Digital Recorder or PDR) or remotely. A resolution provider does location resolution. Resolution providers use resolving authority records (RARs) to be identified and located. A RAR includes at least an <authority> field, corresponding to a body that creates CRIDs.

A RAR also contains a URL and the resolution provider name. The URL points to the location where resolution information can be found. The resolution provider name contains the name of the body that is providing location resolution. These RARs are made available to PDRs.

The CRID for the content item is used to facilitate automatic recording of the content item. The CRID could be entered manually by the user, or be the result of selecting a content item through an Electronic Program Guide. This second option assumes that the CRID is somehow provided to the PDR together with other metadata used in the EPG. Alternatively, if the CRID is not known by the user or by the PDR, the user could perform a search using for example the title of the content item in a metadata database, and select the desired content item from the search results. The CRID is then supplied to the PDR by the search engine.

There are many other ways to provide the CRID to the PDR. For example, a trailer or preview for a movie could be broadcast with the CRID embedded in the content of the commercial in some way (e.g. a watermark). The user could then press a button on his remote control, television or PDR. The PDR or television then extracts the CRID from the content.

Once the CRID for the content item is known, the PDR tries to obtain locator information for the content item, using the CRID as input. This locator information is not necessarily always available. For example, the CRID may refer to a movie that has only recently been released in movie theaters. This movie is not likely to be broadcast on television in the near future, so it cannot be scheduled using EPG information. In such a case, the PDR should regularly try to obtain the locator, as the locator may become available later (e.g. a year later, when the movie is going to be broadcast on TV). The CRID could also refer to a TV series, which is then resolved into a number of CRIDs for individual episodes of that series. It is possible that no locator information is available for some episodes. Here the PDR should also regularly retry to obtain the locator(s) for those episodes.

The process of translating a CRID into other CRIDs or locators is known in TV-Anytime as location resolution. Location resolution involves mapping a location-independent content reference (the CRID) to its location in time (e.g. scheduled transmission time in a broadcast system) and space (e.g. TV channel, IP address). As explained above, these locations in time and space are referred to as “locators.” The process of location resolution may happen inside the PDR or by using a physically remote server, such as a server on the Internet.

To the PDR, the CRID essentially contains opaque information, which it cannot resolve to a location without external assistance. A Resolution Provider (RP) who provides locator information for CRIDs is provided to solve this problem. Usually multiple RPs are available, and the PDR must know which RP to use for a particular CRID. Often, this is the same body that created the CRID. The name of the authority is present in the CRID in the <authority> field, as explained above. This name is present in the form of a registered Internet domain name. It is possible for a Resolution Authority (RA) to be found on the Internet using the domain name resolution process specified in the TV-Anytime specification SP004.

Each RA will require one or more Resolving Authority Records (RAR) to exist in the PDR for location resolution to take place. Each resolving authority record will need to be placed inside some sort of transport specific container that allows the PDR to know that this is a RAR. In the case of multiple records for the same authority, the PDR can choose to just use one of them, or try them all in turn. The Resolving Authority Record (RAR) contains the information that identifies the RA and the RPs where content reference resolution information can be found.

Using the RAR, the PDR determines which RP to use to resolve a particular CRID. The PDR then submits a request for a location accompanied by a CRID to the Resolution Provider in question. In response to this request, the Resolution Provider returns the locator information (assuming this information is available in that RP, of course). The PDR can then access the content source and obtain the content item. A content item may have more than one locator, for example if it is broadcast multiple times or available from multiple providers. The PDR may then choose which locator to use, or prompt the user to make a selection.

Once the locator information has been obtained, the PDR waits for the specified date and time and then records the episode as it is broadcast on the specified channel. Of course, if the locator indicates a location on the Internet or the like, the PDR can simply retrieve the content from the indicated location as soon as it becomes available.

The overview of FIG. 1 shows the various parties involved for the present invention. The invention uses the CRID explained above for referring to content items. There is a broadcaster 102 who transmits a signal 104 containing TV-based content items like talk shows, movies, episodes of a series and the like. The signal 104 is received by a television set 106 at a subscriber's location. The transmission mechanism between the broadcaster and the user's location is not relevant to the invention. The transmission channel may be a satellite link whereby the signal is received at the user's location, or a satellite link to a head end and a cable connection between the head end and the user's location, or a terrestrial broadcast or any other suitable mechanism. The transmission may be carried out in digital form, for example according to the Digital Video Broadcast standard, but may also be in analog form. Instead of a television set, the signal may be received by a so-called set-top box. Such a set-top box processes the received signal, e.g. descrambles and decodes the signal, so that it may be displayed on a simple display device. Furthermore, there is a CRID provider 108 providing CRIDs for the various content items. For the purpose of explaining the invention, the CRID provider is regarded as a single party, but providing a new CRID may be done by different parties and in a hierarchical way. For example, the may be one central party who defines CRIDs at the highest level and who provides ranges of CRIDs to be further filled in by a party like a broadcaster. Nevertheless, for understanding the present invention it suffices to know that a CRID exists to refer to a particular content item. According to the invention, the CRID is used to refer to a content item that should be blocked by the user's television set 106, i.e. the television set should block the reproduction of that content item. Given a particular CRID, the next step is to determine when the content item will be broadcast. As described above, this process is called resolution. The Resolution Provider 110 provides on request the scheduled time and channel of the particular CRID. The Resolution Provider operates closely with the broadcaster, since it is the broadcaster who determines the schedule. Often, the broadcaster provides the role of resolution provider. Thus, when a user becomes aware of a content item that should be blocked by the television set, the user obtains a CRID and stores this in the television set. The television then regularly checks whether the content item is scheduled for broadcast and if so, the television blocks itself for the indicated channel and time. The CRID preferably remains stored in the television set to allow continued checking of further broadcasts of the content item.

There are various ways through which a user may obtain a CRID and store it in the television set. A very simple way is where the CRID of a content item is printed, e.g. in a newspaper with review of that content item, and where the television set has a user interface for entering the CRID. The user then selects a specific blocking registration function of the television and manually enters the CRID into the television set. The user interface may be realized through menus in an On Screen Display, i.e. menus displayed on the television, and the keys of the remote control or other keyboard. Another way is to embed the CRID of a particular content item during a certain period in the signal 104 broadcast to the television set and to allow the user during this period to indicate that the CRID must be stored. Examples of techniques to embed the CRID are to code the CRID in one or more lines of the Vertical Blanking Interval (VBI) of an analog television signal or transport the CRID via a data channel in the case of a digital transmission as DVB. An advantageous implementation of this way of providing the CRD) to the user is the following. In a certain commercial, a particular movie is advertised and during this commercial the CRID of the movie is present in the signal 104. The user is made aware of this presence, e.g. through a notification on the display. If the user decides that he wants to block his television for future broadcasts of the movie, he may simply press a designated key, the block key, on his remote control. Then the television retrieves the CRID from the signal and stores it for later blocking as described above. Alternative to a commercial for a particular movie, the same mechanism can be used in a show where various movies or other programs are presented and reviewed by the presenter or a panel or the like. A still further way through which a user may obtain a CRID is with the help of a party who provides advice regarding the suitability of content items and who provides the corresponding CRIDs. This party, referred to as blocking advisor 111, collects information about content items that come available and their corresponding CRIDS, e.g. from the CRID provider 108. Furthermore, the blocking advisor forms an opinion about the suitability of the content item for certain groups of viewers. The blocking advisor may do so on the basis of personally viewing the content items or on the basis of reviews and critics from other parties. The blocking advisor categorizes the content items into lists corresponding with their suitability, e.g. a list with content items to be blocked for children under 6, a list with content items to be blocked for children under 12, under 16, etc. Additionally or alternatively, the lists may be based on the reasons as to why the content items are regarded unsuitable, e.g. a list with content items to be blocked because of the presence of too much violence, a list with content items to be blocked because of the presence of sex, because of the presence of blasphemy, etc. The user of television set 106 selects a list with content items to be blocked from the available lists at the blocking advisor 111 and retrieves the CRIDs associated with that list via a connection 112. This connection 112 can be an Internet connection through which the user may browse the site of the blocking advisor 111 and download the CRIDs.

FIG. 2 schematically shows the most important components of a reproduction device according to the invention. The reproduction device 200 has an obtaining unit 202 for obtaining one or more CRIDs of content items that are to be blocked. These CRIDs are stored in CRID storage unit 204 from where they will be used regularly to check the availability of the content items that they identify, i.e. they are regularly used for content resolution. The reproduction device 200 optionally has a resolution unit 206 to perform this content resolution. The result of the content resolution, this is a so-called locator indicating the scheduled availability of the content item, is stored in locator storage unit 208. If the reproduction device has no resolution unit of its own, it can request external content resolution on the basis of its stored CRIDs via connection 209 and receives the locators in locator storage unit 208. A blocking unit 210 checks the locator storage unit to determine whether blocking needs currently to be done. To this end, blocking unit 210 receives information regarding the current channel and time via connection 212. If blocking needs to be done, the blocking unit sends a blocking signal indicating this back via connection 212. Alternatively to receiving the current time via connection 212, the blocking unit may determine the current time from an internal clock. The reproduction device 200 optionally has an overriding unit 214 that is able to override the blocking unit 210. If the overriding unit 214 receives a proper authorization signal 216 it overrides any blocking set by the overriding unit. In this way, the reproduction of a content item will be effected, even if based on the stored CRID reproduction should be blocked. Such mechanism can be used for parental control where only the parent can provide the proper authorization signal 216. The authorization signal 216 may be determined on the basis of an authentication technology that is known per se. Examples of such authentication technology are: a password, smart card with a key, finger print recognition and voice recognition. The reproduction device 200 is implemented according to a known computer architecture. The various units are implemented as software components with instructions that are loaded into the working memory of the device. A processor of the device executes the instructions to perform the functions of these components. Alternatively, the reproduction device may be implemented by means of dedicated hardware components.

FIG. 3 schematically shows a system for providing blocking information according to the invention. This system is arranged to provide this as CRIDs to reproduction devices as described above. The system is implemented on a general-purpose computer 302, like a personal computer, according to a known architecture. The various functions of the system in this embodiment are realized in respective software components as described below. This is an exemplary embodiment and another way of mapping the functions onto units is also feasible. The system has a working memory 304 into which the various software units are loaded for execution. The further structure for executing and controlling operation of the computer is not shown in FIG. 3. The computer has an interface 306 for communicating with the peripheral devices. The system has a display device 308 on which the images are displayed. Furthermore, the system has input devices, like keyboard 310 and mouse 312, with which a user can enter commands and data. The system has a storage device 314 on which software components, advisory lists with CRIDs, and other data may be stored. This storage device is a magnetic disk drive but other suitable storage devices may be used. Furthermore, the system has a network connection 316 for connecting to a network, like the Internet. The system has a preparation unit 318 that prepares the advisory lists, e.g. the advisory list 320 shown in the figure. The advisory list 320 refers to a number of content items 322, 324 and 326 indicating that reproduction of these content items is advised to be blocked. It is to be noted that these content items themselves are not stored in the system. The advisory list 320 only refers to the content items 322, 324 and 326. To this end, the advisory list 320 contains respective CRIDs 328, 330 and 332. The system 300 further contains a managing unit 334 that makes the stored advisory list available to be accessed. A user of a reproduction device may connect to the system through network connection 316 and browse through the advisory lists stored on storage device 314. Upon selecting a specific advisory lists, the CRIDs of this selected lists are downloaded via the network connection 316 and stored in the user's reproduction device. There, the CRIDs are used for controlling blocking the reproduction device as described above.

FIG. 4 schematically shows a set-top box according to the invention. The set-top box 400 contains a receiver 402 for receiving content items via an input 404. The content items can be transmitted to the set-top box in one of various way, as described in connection with FIG. 1. The received content items are processed in the set-top box with a processing unit 406 and subsequently sent out via output 408, e.g. for display or recording. The set-top box 400 further contains a reproduction device 200 as described above. The reproduction device may receive CRIDs from the receiver 402 or via an input 410, which may either for manual entry or retrieval through a network. The reproduction device controls the processing unit 406 for blocking the processing of certain content items on the basis of stored CRIDs.

FIG. 5 schematically shows a television according to the invention. The television 500 contains a receiver 502 for receiving content items via an input 504. The content items can be transmitted to the television in one of various way, as described in connection with FIG. 1. The received content items are processed in the television with a processing unit 506 to be displayed on a display device 508, e.g. a CRT. The television 500 further contains a reproduction device 200 as described above. The reproduction device may receive CRIDs from the receiver 502 or via an input 510, which may be done either through manual entry or through retrieval via a network. The reproduction device controls the processing unit 506 for blocking the display of certain content items on the basis of stored CRIDs.

FIG. 6 schematically shows a video recorder according to the invention. The video recorder 600 contains a receiver 602 for receiving content items via an input 604. The content items can be transmitted to the video recorder in one of various way, as described in connection with FIG. 1. The video recorder 600 contains a reproduction device 200 as described above. The reproduction device may receive CRIDs from the receiver 602 or via an input 610, which may be either via manual entry or via retrieval through a network. The reproduction device checks whether reproduction of the received content items is to be blocked and provides a corresponding blocking signal as described in connection with FIG. 2. The video recorder 600 has a storing unit 605 for storing the content items and if present the blocking signal on a storage medium 606. This storage medium 606 is a hard disk, but other suitable media like a CD-RW may be used. Furthermore, the video recorder 600 has a retrieving unit 608 for retrieving a stored content item from the storage medium 606. This is only allowed if no blocking signal has been stored for this content item, i.e. it is only allowed if the reproduction device 200 had established that no blocking was required for this content item. If blocking was required and there is such blocking signal, than a special authorization is required in order to activate the retrieving unit. To this end, the video recorder contains an overriding unit as described in connection with FIG. 2. The content items retrieved from the storage medium are processed and subsequently sent out via output 612, e.g. for display or recording.

It should be noted that the above-mentioned embodiments illustrate rather than limit the invention and that those skilled in the art will be able to design many alternative embodiments without departing from the scope of the appended claims. In the claims, any reference signs placed between parentheses shall not be construed as limiting the claim. The word ‘comprising’ does not exclude the presence of elements or steps other than those listed in a claim. The word “a” or “an” preceding an element does not exclude the presence of a plurality of such elements. The invention can be implemented by means of hardware comprising several distinct elements and by means of a suitably programmed computer. In the unit claims enumerating several means, several of these means can be embodied by one and the same item of hardware.

1. A method of conditionally blocking reproduction of content items on a reproduction device, the method comprising:
obtaining a content reference identifier for a particular content item to be blocked,
resolving the content reference identifier into a locator indicating availability of the particular content item, and
blocking the reproduction device for the indicated availability.

2. A method as claimed in claim 1, wherein the content items are broadcast and the reproduction device is arranged to receive broadcast content items, wherein the locator indicates a scheduled broadcast of the particular content item at a specific time on a specific channel, and wherein the reproduction device is blocked for reproduction for the specific time and channel.

3. A method as claimed in claim 1, wherein the content items reside on a server available for transfer on a request from the reproduction device, wherein the locator indicates the availability of the content item at the server during a specific period of time, and wherein the reproduction device is blocked for retrieval of the content item from the server for the specific period of time.

4. A method as claimed in claim 1, wherein blocking of the reproduction device is reversed by a user with a proper authorization.

5. A method as claimed in claim 4, wherein the proper authorization is determined by at least one of: entry of a password, entry of a smart card, recognition of a finger print, and voice recognition.

6. A method as claimed in claim 1, wherein obtaining the content reference identifier of the particular item includes:
selecting from an external location an advisory list containing at least a reference to the particular content item, and
receiving content reference identifiers for the content items referred to on the list.

7. A method as claimed in claim 1, wherein obtaining the content reference identifier of the particular item includes:
receiving a signal representing a further content item and containing the content reference identifier,
during reproduction of the further content item enabling a user to indicate storing the content reference identifier,
upon the user so indicating, storing the content reference identifier.

8. A method of providing blocking information for conditionally blocking reproduction of content items on a reproduction device, the method comprising:
preparing an advisory list containing a reference to a particular content item and containing a content reference identifier for that particular content item, and
making the advisory list available for transfer to and use in the reproduction device for
resolving the content reference identifier into a locator indicating availability of the particular content item, and
blocking the reproduction device for the indicated availability.

9. A method as claimed in claim 8, wherein the advisory list is stored on a server, and wherein a user is enabled for selecting the list for transfer to the reproduction device.

10. A method as claimed in claim 8, wherein the advisory list is broadcast to the reproduction device and wherein the user is enabled to indicate storing the advisory list in the reproduction device.

11. A reproduction device for conditionally blocking reproduction of content items, the device comprising:
obtaining means for obtaining a content reference identifier for a particular content item to be blocked,
receiving means for receiving the result of resolving the content reference identifier into a locator indicating availability of the particular content item, and
blocking means for blocking the reproduction device for the indicated availability.

12. A reproduction device as claimed in claim 11, wherein the reproduction device comprises resolution means for resolving the content reference identifier into the locator and wherein the receiving means are arranged to receive the result from the resolution means.

13. A set-top box for reproducing content items comprising:
a receiver for receiving the content items, and
a reproduction device for conditionally blocking reproduction of one or more content items as claimed in claim 11.

14. A television set for reproducing content items comprising:
a receiver for receiving the content items,
a reproduction device for conditionally blocking reproduction of one or more content items as claimed in claim 11, and
a display for displaying the content items not blocked by the reproduction device.

15. A video recorder for storing and reproducing content items comprising:
a receiver for receiving the content items,
a reproduction device for indicating conditionally blocking of reproduction of one or more content items as claimed in claim 11,
storing means for storing the content items on a storage medium, and
retrieving means for retrieving the content items from the storage medium.

16. A system for providing blocking information for conditionally blocking reproduction of content items on a reproduction device, the system comprising:
preparation means for preparing an advisory list containing a reference to a particular content item and containing a content reference identifier for that particular content item, and
managing means for making the advisory list available for transfer to and use in the reproduction device for
resolving the content reference identifier into a locator indicating availability of the particular content item, and
blocking the reproduction device for the indicated availability.
